(19) United States
(12) Patent Application Publication
(10) Pub. No.: US 2017/0014735 A1
(43) Pub. Date: Jan. 19, 2017

(54) FILTER DEVICE HAVING COMPOSITE FILTER CORE

(71) Applicant: Xiamen Runner Industrial Corporation, Xiamen (CN)

(72) Inventors: Xian-liang Guo, Xiamen (CN); Jian-yong Yan, Xiamen (CN); Hui-fen Zeng, Xiamen (CN)

(21) Appl. No.: 15/175,364

(22) Filed: Jun. 7, 2016

(30) Foreign Application Priority Data
Jul. 17, 2015 (CN) 201520520124.2

(51) Int. Cl. B01D 29/58; B01D 29/15; B01D 29/90

(52) U.S. Cl. CPC B01D 29/58; B01D 29/902; B01D 29/15; B01D 2201/165

(57) ABSTRACT

A filter device having composite filter core, comprising: a shell, of a barrel-shape; a composite valve, fixed onto an upper end of the shell, with its upper side provided with a water input port and a water output port side by side, and connected respectively to an outside water pipe; a first filter core, of a barrel-shape, disposed longitudinally in the shell, and fixed onto bottom of the shell; a second filter core, sleeved in the first filter core, and fixed onto bottom of the shell; a water purifying tube, having openings at both ends, with its one end connected to the water output port, and with its other end connected into the second filter core; and a baffle, disposed on both sides of the water purifying tube and extending outward, and fastened to outer side of the first filter core.

### BACKGROUND OF THE INVENTION

Field of the Invention

The present invention relates to a filter device, and in particular to a filter device having composite filter core.

The Prior Arts

Presently on the market, most of the single stage filter devices are equipped with a single filer core to provide simple filtering function, thus they are not capable of filtering water of poor quality effectively. In addition, presently, the composite filter core is formed by collapsible diaphragm and Granular Activated Carbon (GAC), yet they are not effective in filtering out organic materials in water having high Chemical Oxygen Demand (COD).

Therefore, presently, the design of the filter device is not quite satisfactory, and it leaves much room for improvement.

### SUMMARY OF THE INVENTION

In view of the problems and drawbacks of the prior art, the present invention provides a filter device having composite filter core, to raise the effectiveness and efficiency of filtering water.

In order to achieve the objective mentioned above, the present invention provides a filter device having composite filter core, comprising: a shell, a composite valve, a first filter core, a second filter core, a water purifying tube, and a baffle. The shell is of a barrel-shape. The composite valve is fixed onto an upper end of the shell, with its upper side provided with a water input port and a water output port side by side, and are connected respectively to an outside water pipe. The first filter core is of a barrel-shape, disposed longitudinally in the shell, and is fixed onto bottom of the shell. The second filter core is sleeved in the first filter core, and is fixed onto bottom of the shell. The water purifying tube is provided with openings at both ends, with its one end connected to the water output port, and with its other end connected into the second filter core. The baffle is disposed on both sides of the water purifying tube and extending outward, and is fastened to outer side of the first filter core.

In an aspect of the present invention, the filter device having composite filter further includes a fixed seat, disposed at bottom end of the shell, for fixing the first filter core and the second filter core, while two fastening slots are provided on the fixed seat, for receiving the first filter core and the second filter core.

In another aspect of the present invention, the baffle is disposed laterally and is of an L-shape, an end of a horizontal portion of the baffle is connected fixedly to the water purifying tube, while a vertical portion of the baffle is disposed on an outer side of the first filter core.

In yet another aspect of the present invention, the water input port is located on a side edge of the composite valve.

In a further aspect of the present invention, the first filter core is a polyethylene (PE) filter core, or a polypropylene (PP) melt-blown filter core.

In an aspect of the present invention, the second filter core is an active carbon rod filter core.

In another aspect of the present invention, the first filter core is an active carbon rod filter core.

In a further aspect of the present invention, the first filter core and the second filter core are located in a middle section of the shell.

Compared with the Prior Art, the present invention has the advantages that, it adopts a composite filter core set formed by an outer PE filter core and an inner active carbon rod filter core, such that in treating water of inferior quality, firstly, the PE filter core filters out the suspending particles such as dirt, sand, rust; then, the active carbon rod filter core filters out the remaining chlorine, and organic material of high COD in the water, in achieving raised filtering effectiveness and efficiency.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of a filter device having composite filter core according to an embodiment of the present invention.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

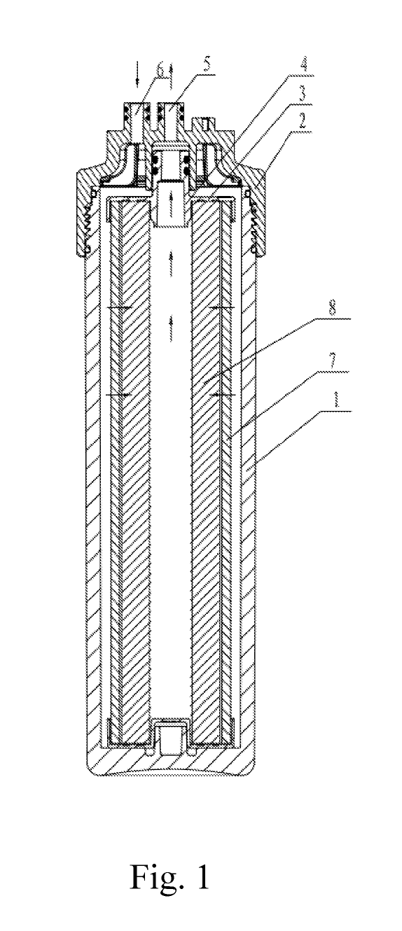

Refer to FIG. 1 for a schematic diagram of a filter device having composite filter core according to an embodiment of the present invention.

As shown in FIG. 1, the present invention provides a filter device having composite filter core, comprising: a shell 1, a composite valve 2, a first filter core 7, a second filter core 8, a water purifying tube 3, and a baffle 4. The shell 1 is of a barrel-shape. The composite valve 2 is fixed onto an upper end of the shell 1, with its upper side provided with a water input port 6 and a water output port 5 side by side, and are connected respectively to an outside water pipe. The first filter core 7 is of a barrel-shape, disposed longitudinally in the shell 1, and is fixed onto bottom of the shell 1. The second filter core 8 is sleeved in the first filter core 7, and is fixed onto bottom of the shell 1. The water purifying tube 3 is provided with openings at both ends, with its one end connected to the water output port 5, and with its other end connected into the second filter core 8. The baffle 4 is disposed on both sides of the water purifying tube 3 and extending outward, and is fastened to outer side of the first filter core 7.

Therefore, the advantage of the present invention is that, through the double filtering of the first filter core 7 and the second filter core 8, the effectiveness of filtering is improved significantly.

The filter device having composite filter core further includes a fixed seat, disposed at bottom end of the shell 1, for fixing the first filter core 7 and the second filter core 8. While two fastening slots are provided on the fixed seat, for receiving the first filter core 7 and the second filter core 8. Through the application of the fixed seat, the first filter core 7 and the second filter core 8 can be fixed and prevented from moving.

The baffle 4 is disposed laterally and is of an L-shape, an end of a horizontal portion of the baffle 4 is connected fixedly to the water purifying tube 3, while a vertical portion of the baffle 4 is disposed on an outer side of the first filter core 7. Through application of the baffle 4, the water coming into the shell 1 through the water input port 6 can be prevented from entering into the second filter core 8 directly. In addition, in the second filter core 8, the water filtered can be prevented from mixing with the unfiltered water.

The water input port 6 is located on a side edge of the composite valve 2. The reason for placing the water input port 6 at side edge is that, water flowing in from the water input port 6 will flow along the inner edge of the shell 1 toward its central portion. During this process, water will pass through the first filter core 7 and the second filter core 8 to be filtered twice. After filtering, water will flow out from the water purifying tube 3 extending out from the second filter core 8.

The first filter core 7 is of a polyethylene (PE) filter core or a polypropylene (PP) melt-blown filter core, and that is used to filter out the suspending particles, such as dirt, sand, or rust in the water.

The second filter core 8 is of an active carbon rod filter core, such that through this second filter core 8, the water filtered above is further filtered out the remaining chlorine and organic material of high COD.

The first filter core 7 and the second filter core 8 are located in a middle section of the shell 1.

From the structure mentioned above, it can be known the advantage of the present invention is that, through the double filtering performed by the first filter core 7 and the second filter core 8, better water filtering effect can be achieved.

Summing up the above, in the present invention, the filter device having composite filter core is simple in construction, and is capable of achieving better filtering effect.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A filter device having composite filter core, comprising:
a shell, of a barrel-shape;
a composite valve, fixed onto an upper end of the shell, with its upper side provided with a water input port and a water output port side by side, and connected respectively to an outside water pipe;
a first filter core, of a barrel-shape, disposed longitudinally in the shell, and fixed onto bottom of the shell;
a second filter core, sleeved in the first filter core, and fixed onto bottom of the shell;
a water purifying tube, having openings at both ends, with its one end connected to the water output port, and with its other end connected into the second filter core; and
a baffle, disposed on both sides of the water purifying tube and extending outward, and fastened to outer side of the first filter core.

2. The filter device having composite filter core as claimed in claim 1, further comprising:
a fixed seat, disposed at bottom end of the shell, for fixing the first filter core and the second filter core, while two fastening slots are provided on the fixed seat, for receiving the first filter core and the second filter core.

3. The filter device having composite filter core as claimed in claim 1, wherein the baffle is disposed laterally and is of an L-shape, an end of a horizontal portion of the baffle is connected fixedly to the water purifying tube, while a vertical portion of the baffle is disposed on an outer side of the first filter core.

4. The filter device having composite filter core as claimed in claim 1, wherein the water input port is located on a side edge of the composite valve.

5. The filter device having composite filter core as claimed in claim 1, wherein the first filter core is one of the following: a polyethylene (PE) filter core, and a polypropylene (PP) melt-blown filter core.

6. The filter device having composite filter core as claimed in claim 1, wherein the second filter core is an active carbon rod filter core.

7. The filter device having composite filter core as claimed in claim 1, wherein the first filter core is an active carbon rod filter core.
